(19) United States
(12) Patent Application Publication
(10) Pub. No.: US 2012/0127147 A1
(43) Pub. Date: May 24, 2012

(54) Liquid Crystal Display and Driving Method Thereof

(75) Inventors: Jin-Wook Yang, Yongin-City (KR); Sang-Jae Yeo, Yongin-City (KR)

(73) Assignee: SAMSUNG MOBILE DISPLAY CO., LTD., Yongin-City (KR)

(21) Appl. No.: 13/051,118

(22) Filed: Mar. 18, 2011

(30) Foreign Application Priority Data
Nov. 22, 2010 (KR) 10-2010-0116258

(51) Int. Cl. G09G 3/36; G09G 5/00

(52) U.S. Cl. 345/212; 345/87

(57) ABSTRACT

A liquid crystal display having: a liquid crystal display panel comprising a plurality of pixels; a data driver applying a data voltage to a plurality of data lines connected to the plurality of pixels; an initial voltage driver applying an initial voltage to the plurality of data lines before the data voltage is applied; and a boost driver applying a boost voltage to a plurality of boost lines connected to the plurality of pixels and boosting voltages of the plurality of pixels to which the data voltage is applied. Crosstalk caused by noise generated in a boost line can be reduced by coupling with a data line, and an ALS driving scheme can be applied to a liquid crystal display having high resolution.

### CLAIM OF PRIORITY

This application makes reference to, incorporates the same herein, and claims all benefits accruing under 35 U.S.C. §119 from an application earlier filed in the Korean Intellectual Property Office on Nov. 22, 2010 and there duly assigned Serial No. 10-2010-0116258.

### BACKGROUND OF THE INVENTION

1. Field of the Invention

The present invention relates to a liquid crystal display (LCD) and a driving method thereof, and more particularly, to a liquid crystal display, which uses an ALS (Active Level Shifter) driving scheme, and a driving method thereof.

2. Description of the Related Art

As a representative display device, a liquid crystal display (LCD) includes two display panels having pixel electrodes and a common electrode, and a liquid crystal layer having dielectric anisotropy therebetween. The pixel electrodes are arranged in a matrix form and are each connected to a switching element such as a thin film transistor (TFT) to sequentially receive a data voltage on a row by row basis. The common electrode is formed over an entire surface of the display panel to receive a common voltage. The pixel electrodes, the common electrode, and the liquid crystal layer therebetween constitute a liquid crystal capacitor from a circuital view, and the liquid crystal capacitor and a switching element connected thereto become a basic unit constituting a pixel.

In the LCD, an electric field is generated in a liquid crystal layer by applying a voltage to two electrodes, and a desired image is obtained by adjusting the transmittance of light passing through the liquid crystal layer by adjusting the intensity of the electric field. However, if a one-directional electric field is applied to the liquid crystal layer for a relatively long period of time, image degradation will occur. To prevent this, the polarities of the data voltages with respect to the common voltage are inverted in units of either a frame of pixels, a row of pixels, or a single pixel.

An ALS (Active Level Shifter) driving scheme is a driving scheme for boosting the voltage of a pixel, in which a voltage of the pixel electrode in a floating state after a gate voltage turns off is boosted by coupling with a boost voltage. The boosting of the voltage of the pixel electrode can be induced by raising or dropping the voltage of a boost line during one frame. Such an ALS driving scheme can reduce power consumption because the source output voltage of a driving circuit can be lowered. Moreover, the ALS driving scheme can increase the pixel voltage and improve liquid crystal response speed by applying a high pixel voltage.

However, the direction of the boost line coincides with the direction of a scan line and overlaps with a data line. Thus, the boost voltage of the boost line may have noise by coupling with a data voltage applied to the data line.

For example, when a gate-on voltage is applied to the scan line to apply a data voltage to the data line, a noise voltage is generated in the boost line by coupling with the data line. The noise voltage generated in the boost line has to be recovered until the application of a gate-off voltage and the application of a boost voltage. If the noise voltage generated in the boost line is not recovered until the application of a boost voltage, an output signal of the boost line fluctuates by the noise voltage and then is output.

A noise voltage deviation of the boost line, which is not recovered, causes a difference in pixel voltage when the gate-off voltage is applied, and this may induce crosstalk.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a liquid crystal display, which reduces crosstalk caused by noise generated in a boost line by coupling with a data line by an ALS driving scheme, and a driving method thereof.

An exemplary embodiment of the present invention provides a liquid crystal display including: a liquid crystal display panel comprising a plurality of pixels; a data driver applying a data voltage to a plurality of data lines connected to the plurality of pixels; an initial voltage driver applying an initial voltage to the plurality of data lines before the data voltage is applied; and a boost driver applying a boost voltage to a plurality of boost lines connected to the plurality of pixels and boosting voltages of the plurality of pixels to which the data voltage is applied.

The liquid crystal display may further include a signal controller that transmits an initial voltage clock signal for controlling the output of the initial voltage to the initial voltage driver.

The initial voltage driver may include: a first transistor that controls the application of the data voltage to the plurality of data lines by using the initial voltage clock signal as a gate signal; and a second transistor that controls the application of the initial voltage to the plurality of data lines by using the initial voltage clock signal as a gate signal.

The first transistor may further include: a gate terminal to which the initial voltage clock signal is applied; an input terminal to which the data voltage is applied; and an output terminal connected to the data lines.

The second transistor may further include: a gate terminal to which the initial voltage clock signal is applied; an input terminal to which the initial voltage is applied; and an output terminal connected to the data lines.

The first transistor and the second transistor may be different field effect transistors.

The first transistor may be an n-channel field effect transistor, and the second transistor may be a p-channel field effect transistor. The first transistor may be a p-channel field effect transistor, and the second transistor may be an n-channel field effect transistor.

The initial voltage clock signal may be a clock signal comprising a combination of a logic high level voltage and a logic low level voltage.

Another exemplary embodiment of the present invention provides a driving method of a liquid crystal display, the method including: applying an initial voltage to a data line connected to a pixel to charge a liquid crystal capacitor of the pixel with the initial voltage; applying a data voltage to the data line to charge the liquid crystal capacitor with the data voltage; and applying a boost voltage to a boost line connected to the pixel to boost the voltage of the liquid crystal capacitor.

The method may further include: applying a scan signal of a gate-on voltage to a scan line connected to the pixel to turn on a switching transistor comprising an input terminal connected to the data line, an output terminal connected to the liquid crystal capacitor, and a gate terminal connected to the scan line.

A period during which the scan signal of the gate-on voltage is sustained may include a period for applying the initial voltage and a period for applying the data voltage.

The length of the period for applying the initial voltage may be set equal to the length of the period for applying the data voltage. The initial voltage may be a voltage having a lower level than the data voltage. The initial voltage may be a predetermined fixed voltage. The initial voltage may be variably set in accordance with the level of the data voltage.

Crosstalk caused by noise generated in a boost line can be reduced by coupling with a data line, and an ALS driving scheme can be applied to a liquid crystal display having high resolution.

### BRIEF DESCRIPTION OF THE DRAWINGS

A more complete appreciation of the present invention, and many of the attendant advantages thereof, will become readily apparent as the same becomes better understood by reference to the following detailed description when considered in conjunction with the accompanying drawings in which like reference symbols indicate the same or similar components, wherein:

FIG. 1 is a block diagram showing a liquid crystal display according to an exemplary embodiment of the present invention;

FIG. 2 is an equivalent circuit diagram of one pixel of FIG. 1;

FIG. 3 is a circuit diagram for explaining the operation of the liquid crystal display of FIG. 1; and

FIG. 4 is a timing diagram for explaining the operation of the liquid crystal display of FIG. 1.

### DETAILED DESCRIPTION OF THE INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention.

In several exemplary embodiments, constituent elements having the same configuration are representatively described in a first exemplary embodiment by using the same reference numeral and only constituent elements other than the constituent elements described in the first exemplary embodiment will be described in other embodiments.

In order to clarify the present invention, elements extrinsic to the description are omitted from the details of this description, and like reference numerals refer to like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising”, will be understood to imply the inclusion of stated elements but not the exclusion of any other elements.

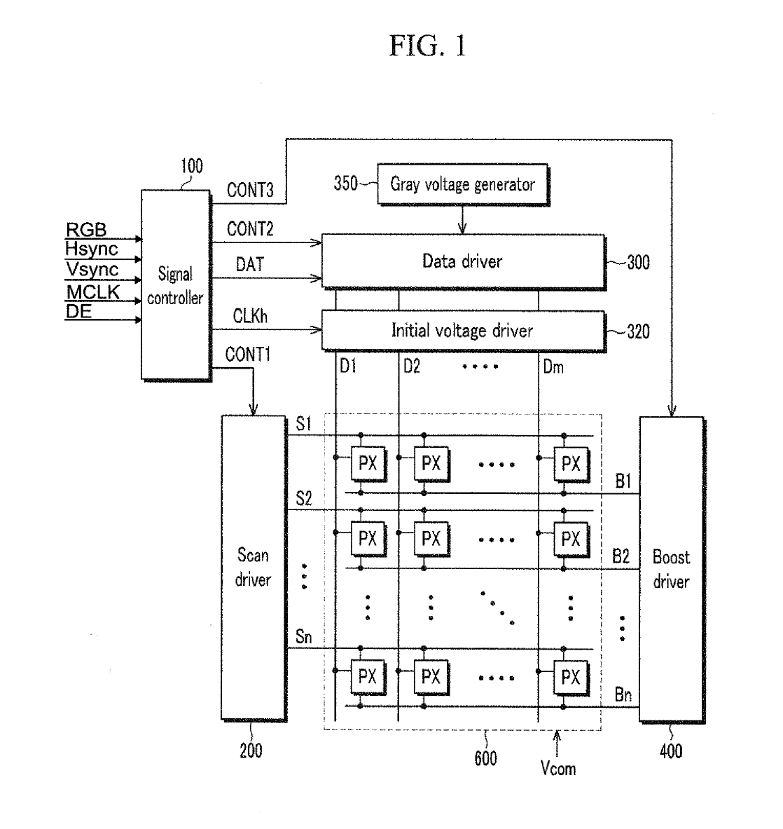

FIG. 1 is a block diagram showing a liquid crystal display according to an exemplary embodiment of the present invention.

Referring to FIG. 1, a liquid crystal display comprises a liquid crystal panel assembly 600, a scan driver 200 connected to the liquid crystal display panel assembly 600, a data driver 300, an initial voltage driver 320, a gray voltage generator 350, a boost driver 400, and a signal controller 100 for controlling each of the drivers.

The liquid crystal panel assembly 600 comprises a plurality of scan lines S1-Sn, a plurality of data lines D1-Dm, a plurality of boost lines B1-Bn, and a plurality of pixels PX. The plurality of pixels PX are connected to the plurality of signal lines S1-Sn, D1-Dm, and B1-Bn and arranged substantially in a matrix. The plurality of scan lines S1-Sn extend substantially in a row direction and are substantially parallel to each other. The plurality of data lines D1-Dm extend substantially in a column direction and are substantially parallel to each other. The plurality of boost lines B1-Bn extend substantially in a row direction corresponding to the scan lines S1-Sn, respectively. At least one polarizer (not shown) for polarizing light is attached to the outer surface of the liquid crystal display panel assembly 600.

The signal controller 100 receives input video signals (R, G, B) and input control signals for controlling the display thereof from an external device. Input video signals (R, G, B) contain luminance information of each pixel PX and the luminance information includes a predetermined number of gray scales, for example, 1024(=2¹⁰), 256(=2⁸), or 64(=2⁶) gray scales. The input control signals include, for example, a vertical synchronization signal Vsync, a horizontal synchronization signal Hsync, a main clock MCLK, and a data enable signal DE.

The signal controller 100 properly processes the input video signals (R, G, B) to match operating conditions of the liquid crystal panel assembly 600 and the data driver 300 based on the input video signals (R, G, B) and the input control signals, and generates a processed image data signal DAT, a scan control signal CONT1, a data control signal CONT2, an initial voltage clock signal CLKh, and a boost control signal CONT3. The scan control signal CONT1 is transmitted to the scan driver 200. The data control signal CONT2 and the image data signal DAT are transmitted to the data driver 300. The initial voltage clock signal CLKh is transmitted to the initial voltage driver 320. The boost control signal CONT3 is transmitted to the boost driver 400.

The signal controller 100 transmits the image data signal DAT and the data control signal CONT2 to the data driver 300. The data control signal CONT2 is a signal for controlling the operation of the data driver 300, and comprises a horizontal synchronization start signal for indicating the start of transformation of the image data signal DAT, a load signal for instructing the data lines D1-Dm to output data voltages, and a data clock signal. The data control signal CONT2 may further comprise an inversion signal for inverting the voltage polarity of the image data signal with respect to a common voltage Vcom.

The signal controller 100 transmits the scan control signal CONT1 to the scan driver 200. The scan control signal CONT1 comprises at least one clock signal for controlling the output of a scan start signal and the output of a gate-on voltage from the scan driver 200. The scan control signal CONT1 may further comprise an output enable signal for defining the duration of the gate-on voltage.

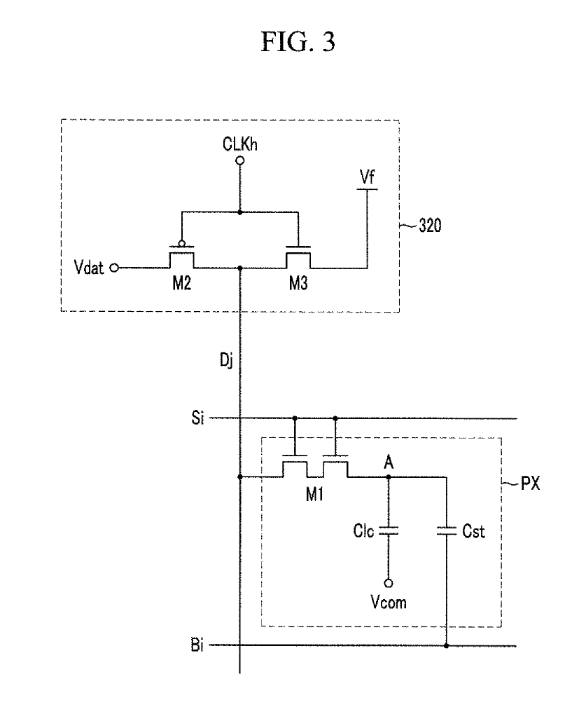

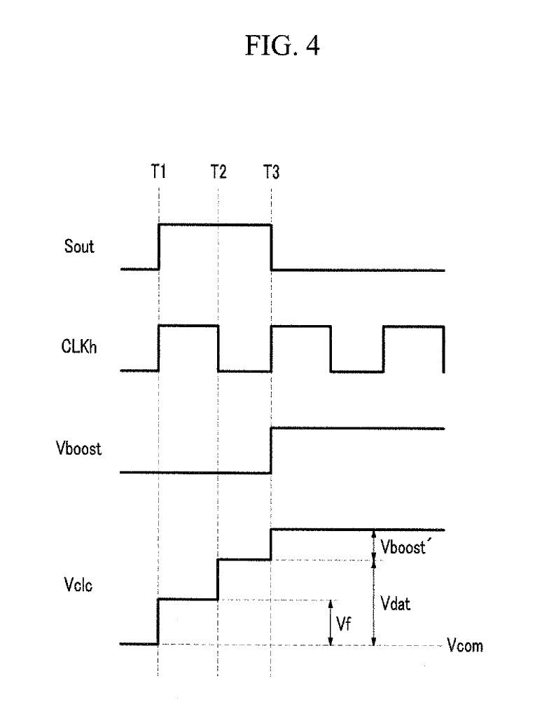

The signal controller 100 transmits the initial voltage clock signal CLKh to the initial voltage driver 320. The initial voltage clock signal CLKh controls the output of an initial voltage Vf (FIGS. 3 and 4) from the initial voltage driver 320.

The signal controller 100 transmits the boost control signal CONT3 to the boost driver 400. The boost control signal CONT3 controls the output of a boost voltage Vboost (FIG. 4) applied to each pixel PX from the boost driver 400.

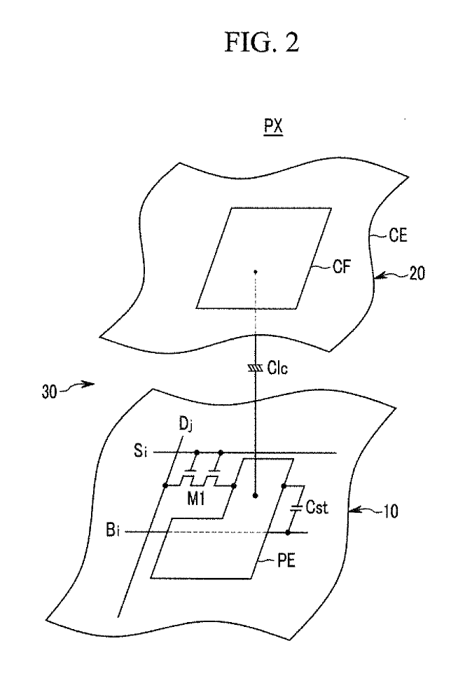

The scan driver 200 is connected to the plurality of scan lines S1-Sn of the liquid crystal display panel assembly 600 and, in response to the scan control signal CONT1, applies a scan signal Sout (FIG. 4) comprising a combination of a gate-on voltage for turning on a switching transistor (M1 of FIG. 2) and a gate-off voltage for turning off the switching transistor M1 to the plurality of scan lines S1-Sn.

The data driver 300 is connected to the data lines D1-Dm of the liquid crystal display panel assembly 600, and applies a data voltage Vdat (FIGS. 3 and 4) to the plurality of data lines D1-Dm. The data driver 300 selects a gray voltage from the gray voltage generator 350, and applies the selected gray voltage as a data signal to the data lines D1-Dm. However, the gray scale voltage generator 350 does not provide a voltage for all grays but provides only a predetermined number of reference gray voltages, and the data driver 300 generates gray voltages for all grays by dividing the reference gray voltages, and selects a data signal among them. At this time, the initial voltage driver 320 applies the initial voltage Vf to the plurality of data lines D1-Dm first before the application of the data voltage Vdat. The initial voltage Vf is a voltage having a lower level than the data voltage Vdat.

The boost driver 400 transmits boost voltages Vboost to the plurality of boost lines B1-Bn of the liquid crystal display panel assembly 600 in response to boost control signal CONT3. The level of each of the boost voltages Vboost applied to the plurality of boost lines B1-Bn is changed in synchronization with the scan signal Sout applied to the corresponding scan line S1-Sn.

The gray scale voltage generator 350 and above-described drivers 100, 200, 300, 320 and 400 may be directly mounted in the form of at least one integrated chip on the liquid crystal panel assembly 600, or may be mounted on a flexible printed circuit film or attached to the liquid crystal panel assembly 300 in the form of a tape carrier package (TCP), or may be mounted on a separate printed circuit board. Alternatively, the gray scale voltage generator 350 and drivers 100, 200, 300, 320 and 400 may be integrated together with the signal lines S1-Sn, D1-Dm, and B1-Bn on the liquid crystal display panel assembly 600.

FIG. 2 is an equivalent circuit diagram of one pixel of FIG. 1.

Referring to FIG. 2, the liquid crystal display panel assembly 600 comprises a thin film transistor display panel 10 and a common electrode (CE) display panel 20 which face each other, a liquid crystal layer 30 sandwiched therebetween, and a spacer (not shown) that maintains a gap between the two display panels 10 and 20 and is compressible to some extent.

Each pixel PX of the liquid crystal display panel assembly 600, for example, a pixel PX connected to an i-th (i=1−n) scan line Si, a boost line Bi, and a j-th (j=1−m) data line Dj, includes a switching transistor M1 and a liquid crystal capacitor Clc and a sustain (storage) capacitor Cst that are connected to the switching transistor M1.

The switching transistor M1 is a three terminal element, such as a thin film transistor, provided in the thin film transistor display panel 10, and comprises a gate terminal connected to the scan line Si, an input terminal connected to the data line Dj, and an output terminal connected to a pixel electrode PE of the liquid crystal capacitor Clc. The thin film transistor includes amorphous silicon or polycrystalline silicon.

The switching transistor M1 may be an n-channel field effect transistor. In this case, the gate-on voltage for turning on the switching transistor M1 is a logic high level voltage, and the gate-off voltage for turning off the switching transistor M1 is a logic low level voltage. Alternatively, the switching transistor M1 may be a p-channel field effect transistor. In this case, the gate-on voltage for turning on the switching transistor M1 is a logic low level voltage, and the gate-off voltage for turning off the switching transistor M1 is a logic high level voltage.

The following description will be made under the assumption that the switching transistor M1 is an n-channel field effect transistor.

The liquid crystal capacitor Clc comprises the pixel electrode PE of the thin film transistor display panel 10 and a common electrode CE of the common electrode display panel 20 facing the thin film transistor display panel 10. That is, the liquid crystal capacitor Clc has the pixel electrode PE of the thin film transistor display panel 10 and the common electrode CE of the common electrode display panel 20 as two terminals. The liquid crystal layer 30 between the pixel electrode PE and the common electrode CE functions as a dielectric material.

The pixel electrode PE is connected to the switching transistor M1, and the common electrode CE is formed over the entire surface of the common electrode display panel 20 and receives a common voltage Vcom. Alternatively, the common electrode CE may be provided on the thin film transistor array panel 10 so that at least one of the pixel electrode PE and the common electrode CE may be formed in a line shape or a bar shape. The common voltage Vcom is a constant voltage of a predetermined level, and may be substantially near 0V.

The sustain capacitor Cst comprises one end connected to the pixel electrode PE and the other end connected to the boost line Bi. The boost line Bi may be provided on the thin film transistor display panel 10, and the boost line Bi and the pixel electrode PE may overlap each other, with an insulator interposed therebetween. A predetermined voltage, such as the common voltage Vcom, may be applied to the boost line Bi.

A color filter CF may be formed in some regions of the common electrode CE of the common electrode display panel 20. To display color, the respective pixels should intrinsically express one of the primary colors (spatial division), or alternately express the primary colors in a temporal order (time division) such that the desired colors can be perceived by the spatial and temporal sum of the primary colors. The primary colors include red, green, and blue colors.

Here, there is shown an example of the spatial division where each pixel has a color filter CF expressing one of the primary colors at the region of the common electrode display panel 20 corresponding to the pixel electrode PE. Alternatively, the color filter CF may be formed over or under the pixel electrode PE of the thin film transistor display panel 10.

FIG. 3 is a circuit diagram for explaining the operation of the liquid crystal display of FIG. 1.

Referring to FIG. 3, a pixel PX connected to the i-th scan line Si and the j-th data line Dj and an initial voltage driver 320 connected to the pixel PX are illustrated.

The initial voltage driver 320 comprises a first transistor M2 for controlling the data voltage Vdat to the data line Dj and a second transistor M3 for controlling the application of the initial voltage Vf to the data line Dj. The first transistor M2 and the second transistor M3 are operated depending on the initial voltage clock signal CLKh as a gate signal.

The first transistor M2 comprises a gate terminal to which the initial voltage clock signal CLkh is applied, an input terminal to which the data voltage Vdat is applied, and an output terminal connected to the data line Dj. The second transistor M3 comprises a gate terminal to which the initial voltage clock signal CLKh is applied, an input terminal to which the initial voltage Vf is applied, and an output terminal connected to the data line Dj.

The same initial voltage clock signal CLKh is applied to the gate terminal of the first transistor M2 and the gate terminal of the second transistor M3. The first transistor M2 and the second transistor M3 are configured as different field effect transistors such that the data voltage Vdat and the initial voltage Vf are optionally applied. For example, the first transistor M2 may be a p-channel field effect transistor, and the second transistor M3 may be an n-channel field effect transistor. Alternatively, the first transistor M2 may be an n-channel field effect transistor, and the second transistor M3 may be a p-channel field effect transistor.

The following description will be made under the assumption that the first transistor M2 is a p-channel field effect transistor and the second transistor M3 is an n-channel field effect transistor.

The initial voltage clock signal CLKh is a clock signal for alternately applying a logic high level voltage and a logic low level voltage during the application of the gate-on voltage to the scan line Si. The initial voltage clock signal CLKh is a clock signal comprising a combination of the logic high level voltage and the logic low level voltage. The initial voltage clock signal CLKh firstly turns on the second transistor M3 to apply the initial voltage Vf to the data line Dj, and thereafter turns on the first transistor M2 to apply the data voltage Vdat to the data line Dj. First of all, when the initial voltage clock signal CLKh is applied at the logic high level voltage, the second transistor M3 serving as the n-channel field effect transistor turns on and the initial voltage Vf is applied to the data line Dj. When the initial voltage clock signal CLKh is applied at the logic low level voltage, the first transistor M2 serving as the p-channel field effect transistor turns on and the data voltage Vdat is applied to the data line Dj.

When the gate-on voltage is applied to the scan line Si, the switching transistor M1 turns on, and, while the second transistor M3 is on, the initial voltage Vf applied to the data line Dj is transmitted firstly to node A. The sustain capacitor Cst and the liquid crystal capacitor Clc are charged in accordance with a difference between the voltage (initial voltage) of node A and the common voltage Vcom. Afterwards, when the first transistor M2 is on, the second transistor M3 is turned off, and the data voltage Vdat applied to the data line Dj is transmitted to node A. The sustain capacitor Cst and the liquid crystal capacitor Clc are charged in accordance with a difference between the voltage (data voltage) of node A and the common voltage Vcom.

When the gate-off voltage is applied to the scan line Si, the switching transistor M1 turns off and node A goes into a floating state. At this time, when a boost voltage Vboost of a predetermined level is applied to the boost line Bi, the voltage of the liquid crystal capacitor Clc is boosted by coupling, corresponding to the boost voltage Vboost. For example, if the boost voltage Vboost rises to a positive voltage with respect to the common voltage Vcom, the voltage of the liquid crystal capacitor Clc also rises. If the boost voltage Vboost falls to a negative voltage with respect to the common voltage Vcom, the voltage of the liquid crystal capacitor Clc also falls. The degree of boosting the voltage of the liquid crystal capacitor Clc that changes with variations in the level of the boost voltage Vboost is determined according to the capacitance ratio of the sustain capacitor Cst to the liquid crystal capacitor Clc.

An electric field is generated in the liquid crystal layer 30 of the liquid crystal capacitor Clc by the difference between the voltage of node A boosted by the boost voltage Vboost and the common voltage Vcom, and an image is displayed by adjusting the transmittance of light passing through the liquid crystal layer 30 of the liquid crystal capacitor Clc. The sustain capacitor Cst keeps the electric field generated in the liquid crystal layer of the liquid crystal capacitor Clc constant. In this way, a data signal is input to each pixel.

By repeating such a process using one horizontal period (may be called “1H”, and is the same as a period of a horizontal synchronization signal Hsync and a data enable signal DE) in units, a gate-on voltage is sequentially applied to all gate lines S1-Sn and a data voltage is applied to all pixels PX, thereby displaying an image of a frame.

When the next frame is started after finishing one frame, the data driver 300 generates a data voltage in accordance with a polarity inversion signal such that the polarity of the data signal applied to each pixel PX is opposite to the polarity of the data signal of a previous frame. This is referred to as frame inversion. Within a single frame, according to the characteristic of the polarity inversion signal, the polarity of the data signals transmitted through a single data line may be inverted (for example, row inversion or dot inversion), or the polarity of the data signals applied to a single pixel row may be different (for example, column inversion or dot inversion).

FIG. 4 is a timing diagram for explaining the operation of the liquid crystal display of FIG. 1.

Referring to FIGS. 1 to 4, at time T1, the scan driver 200 applies a scan signal Sout of a gate-on voltage to the gate terminal of the switching transistor M1 of a pixel PX in response to a scan control signal CONT1 to turn on the switching transistor M1. An output enable signal included in the scan control signal CONT1 may define the gate-on voltage to be sustained from time T1 to time T3, and accordingly the gate-on voltage is sustained from time T1 to time T3.

At time T1, the signal controller 100 transmits an initial voltage clock signal CLKh of logic high level to the initial voltage driver 320. The initial voltage clock signal CLKh of logic high level is applied to the gate terminal of the first transistor M2 and the gate terminal of the second transistor M3. The initial voltage clock signal CLKh of logic high level causes the first transistor M2 to turn off and the second transistor M3 to turn on. The initial voltage clock signal CLKh of logic high level is sustained in the period T1 to T2, which is shorter than the period T1 to T3 during which the scan signal Sout of the gate-on voltage is sustained. An initial voltage Vf is transmitted to the pixel PX in the period T1 to T2 during which the initial voltage clock signal CLKh is applied at logic high level. The liquid crystal capacitor Clc of the pixel PX is charged with a voltage corresponding to a difference between a common voltage Vcom and the initial voltage Vf. That is, the liquid crystal capacitor voltage Vclc is a voltage corresponding to the difference between the common voltage Vcom and the initial voltage Vf. If the common voltage Vcom is about 0V, the liquid crystal capacitor voltage Vclc becomes the initial voltage Vf.

At time T2, the signal controller 100 transmits an initial voltage clock signal CLKh of logic low level to the initial voltage driver 320. The initial voltage clock signal CLKh of logic low level is applied to the gate terminal of the first transistor M2 and the gate terminal of the second transistor M3, and causes the first transistor M2 to turn on and the second transistor M3 to turn off. The initial voltage clock signal CLKh of logic low level is sustained in a period from time T2 to time T3 during which the scan signal Sout of the gate-on voltage is sustained. A data voltage Vdat is transmitted to the pixel PX in the period T2 to T3 during which the initial voltage clock signal CLKh is applied at logic low level. The liquid crystal capacitor voltage Clc of the pixel PX before time T2 is an initial voltage Vf, and the liquid crystal capacitor voltage Vclc at time T2 rises to a voltage corresponding to the difference between the common voltage Vcom and the data voltage Vdat. That is, the liquid crystal capacitor voltage Vclc is a voltage corresponding to the difference between the common voltage Vcom and the data voltage Vdat. If the common voltage Vcom is about 0V, the liquid crystal capacitor voltage Vclc becomes the data voltage Vdat

In the period from time T1 to time T3, the boost driver 400 applies a boost voltage Vboost equal to the common voltage Vcom to a boost line corresponding to the pixel PX. During this period, the sustain capacitor Cst of the pixel PX is charged with the same voltage as the liquid crystal capacitor Clc. That is, the sustain capacitor Cst is also charged with the initial voltage Vf in the period T1 to T2 during which the liquid crystal capacitor voltage Vclc is the initial voltage Vf, and the sustain capacitor is also charged with the data voltage Vdat in the period T2 to T3 during which the liquid crystal capacitor voltage Vclc is the data voltage Vdat.

At time T3, the scan driver 200 applies a scan signal Sout of a gate-off voltage to the gate terminal of the switching transistor M1 of the pixel PX to turn off the switching transistor M1. When the switching transistor M1 turns off, node A goes into a floating state. The boost driver 400 applies a boost voltage Vboost which is higher by a predetermined level than the common voltage Vcom to the other end of the sustain capacitor Cst to boost the voltage of node A in the floating state. The liquid crystal capacitor voltage Vclc is boosted as high as a voltage Vboost' determined according to the capacitance ratio between the liquid crystal capacitor Clc and the sustain capacitor Cst.

When the data voltage Vdat is applied to the data lines D1-Dm, a noise voltage generated in the boost lines B1-Bn by coupling with the data lines D1-Dm is proportional to an instantaneous rate of change of the data voltage Vdat. As described above, the instantaneous rate of change of the voltage in the data lines D1-Dm can be reduced by applying the initial voltage Vf having a lower level than the data voltage Vdat first and then applying the data voltage Vdat before the data voltage Vdat is applied to the data lines D1-Dm.

The noise voltage generated in the boost lines B1-Bn may vary depending on the degree of coupling between the data lines D1-Dm and the boost lines B1-Bn, the magnitude of the boost voltage Vboost, the magnitude of the data voltage Vdat, and so on. In view of this, the magnitude of the initial voltage Vf, the length of the period T1 to T2 in which the initial voltage Vf is applied, the length of the period T2 to T3 in which the data voltage Vdat is applied, and so on.

The length of the period T2 to T3 in which the data voltage Vdat is applied may be defined as a time duration which ensures the charging of the liquid crystal capacitor Clc and the sustain capacitor Cst. The length of the period T2-T3 in which the data voltage Vdat is applied may be defined as a time duration (1 data clock signal) of application of the data voltage in the conventional liquid crystal display. Alternatively, since the data voltage Vdat is additionally charged when the liquid crystal capacitor Clc has been pre-charged with the initial voltage Vf, the period T1 to T2 of application of the initial voltage Vf and the period T2 to T3 of application of the data voltage Vdat may be set to be included in the time duration (1 data clock signal) of application of the data voltage in the conventional liquid crystal display.

The length of the period T1 to T2 of application of the initial voltage Vf may be equal or similar to the length of the period T2 to T3 of application of the data voltage Vdat. The length of the period T1 to T2 of application of the initial voltage Vf is too short, the noise voltage generated by the initial voltage Vf may increase the level of a noise voltage generated by the data voltage Vdat. Therefore, it is desirable to reduce the effect of the noise voltage caused by the initial voltage Vf by setting the length of the period T1 to T2 of application of the initial voltage Vf to be equal or similar to the length of the period T2 to T3 of application of the data voltage Vdat.

The length of the period T1 to T2 of application of the initial voltage Vf and the length of the period T2 to T3 of application of the data voltage Vdat may be adjusted to a time duration in which logic high and low level signals of the initial voltage clock signal CLKh are applied. Alternatively, the signal controller 100 may produce a signal for indicating the length of the period T1 to T2 of application of the initial voltage Vf, i.e., the sustain time of the initial voltage Vf, and transmit it to the initial voltage driver.

The magnitude of the initial voltage Vf may be defined as a predetermined fixed voltage value or may vary depending on the level of the data voltage Vdat. If the magnitude of the initial voltage Vf is defined as a fixed voltage value, the initial voltage Vf may be defined as the minimum value of the data voltage Vdat or a value which is lower by a predetermined level than the minimum value of the data voltage Vdat. If the magnitude of the initial voltage Vf is defined according to the level of the data voltage Vdat, the initial voltage Vf may be set to half of the data voltage Vdat or a voltage corresponding to a predetermined proportion of the data voltage Vdat. That is, the initial voltage driver 320 may output a variable initial voltage Vf depending on the initial voltage Vf having a fixed value or the data voltage Vdat transmitted from the data driver 300.

While the foregoing description has been made in connection with the case where one initial voltage Vf is applied first before application of the data voltage Vdat, a plurality of initial voltages Vf having different levels may be applied first before application of the data voltage Vdat. As at least one initial voltage Vf is applied before application of the data voltage Vdat, a noise voltage generated in the boost lines B1-Bn can be reduced, and crosstalk caused by a noise voltage deviation of the boost lines, which is not recovered, can be reduced.

The drawings referred to hereinabove and the detailed description of the present invention discussed above are merely illustrative and exemplary of the present invention, and should not be construed as defining or limiting the scope of the invention as set forth in the claims. Therefore, those skilled in the art can appreciate that various modifications and other equivalent embodiments can be achieved. Accordingly, the genuine technical protection range of the present invention should be determined by the technical spirit of the claims.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A liquid crystal display comprising:
a liquid crystal display panel comprising a plurality of pixels;
a data driver applying a data voltage to a plurality of data lines connected to the plurality of pixels;
an initial voltage driver applying an initial voltage to the plurality of data lines before the data voltage is applied; and
a boost driver applying a boost voltage to a plurality of boost lines connected to the plurality of pixels and boosting voltages of the plurality of pixels to which the data voltage is applied.

2. The liquid crystal display of claim 1, further comprising a signal controller that transmits an initial voltage clock signal for controlling the output of the initial voltage to the initial voltage driver.

3. The liquid crystal display of claim 2, wherein, for each of the plurality of data lines the initial voltage driver comprises:
a first transistor that controls the application of the data voltage to the data line by using the initial voltage clock signal as a gate signal; and
a second transistor that controls the application of the initial voltage to the data line by using the initial voltage clock signal as a gate signal.

4. The liquid crystal display of claim 3, wherein the first transistor further comprises:
a gate terminal to which the initial voltage clock signal is applied;
an input terminal to which the data voltage is applied; and
an output terminal connected to the data line.

5. The liquid crystal display of claim 3, wherein the second transistor comprises:
a gate terminal to which the initial voltage clock signal is applied;
an input terminal to which the initial voltage is applied; and
an output terminal connected to the data line.

6. The liquid crystal display of claim 3, wherein the first transistor and the second transistor are different field effect transistors.

7. The liquid crystal display of claim 6, wherein the first transistor is an n-channel field effect transistor, and the second transistor is a p-channel field effect transistor.

8. The liquid crystal display of claim 6, wherein the first transistor is a p-channel field effect transistor, and the second transistor is an n-channel field effect transistor.

9. The liquid crystal display of claim 6, wherein the initial voltage clock signal is a clock signal comprising a combination of a logic high level voltage and a logic low level voltage.

10. A driving method of a liquid crystal display, the method comprising:
applying an initial voltage to a data line connected to a pixel to charge a liquid crystal capacitor of the pixel with the initial voltage;
applying a data voltage to the data line to charge the liquid crystal capacitor with the data voltage; and
applying a boost voltage to a boost line connected to the pixel to boost the voltage of the liquid crystal capacitor.

11. The method of claim 10, further comprising: applying a scan signal of a gate-on voltage to a scan line connected to the pixel to turn on a switching transistor comprising an input terminal connected to the data line, an output terminal connected to the liquid crystal capacitor, and a gate terminal connected to the scan line.

12. The method of claim 11, wherein a period during which the scan signal of the gate-on voltage is sustained comprises a period for applying the initial voltage and a period for applying the data voltage.

13. The method of claim 12, wherein a length of the period for applying the initial voltage is set equal to a length of the period for applying the data voltage.

14. The method of claim 10, wherein the initial voltage is a voltage having a lower level than the data voltage.

15. The method of claim 14, wherein the initial voltage is a predetermined fixed voltage.

16. The method of claim 14, wherein the initial voltage is variably set in accordance with the level of the data voltage.
